(19) United States
(12) Patent Application Publication
(10) Pub. No.: US 2026/0233699 A1
(43) Pub. Date: Aug. 13, 2026

(54) VEHICLE SEAT

(71) Applicant: Nissan Motor Co., Ltd., Yokohama-shi (JP)

(72) Inventors: Kenjiro INOUE, Kanagawa (JP); Toma HOSOSAKA, Kanagawa (JP)

(21) Appl. No.: 19/433,196

(22) Filed: Dec. 26, 2025

(30) Foreign Application Priority Data
Feb. 7, 2025 (JP) 2025-019578

(51) Int. Cl. B60R 22/26; B60N 2/64

(52) U.S. Cl. CPC B60R 22/26; B60N 2/643; B60R 2022/266

(57) ABSTRACT

In a vehicle seat including a seat belt mechanism and a seat portion that includes a seat cushion and a seat back, the seat belt mechanism includes: a webbing; an anchor disposed to overlap with the seat portion when viewed from above, an end of the webbing being fixed to the anchor; a buckle provided in the seat cushion; and a tongue to be coupled to the buckle to cause a part of the webbing to function as a waist restraint section to restrain a waist portion of a passenger’s body, in which the anchor is disposed below the seat back and vertically below a rear end of the seat cushion or on a rear side of the rear end of the seat cushion, and a portion of the webbing close to the anchor is pulled upward from between the seat cushion and the seat back.

### CROSS REFERENCE TO RELATED APPLICATIONS

This application claims priority under 35 U.S.C. § 119 to Japanese Patent Application No. 2025-019578 filed February 7, 2025. The entire disclosure of Japanese Patent Application No. 2025-019578 is hereby incorporated herein by reference.

### TECHNICAL FIELD

The present invention relates to a vehicle seat.

### BACKGROUND INFORMATION

There is known a vehicle seat including a seat belt mechanism and a seat having a seat cushion and a seat back. See Japanese Patent Application No. 2020-111168 A.

In a configuration of Japanese Patent Application No. 2020-111168 A, an end of a webbing waist portion opposite to a tongue is supported by a floor anchor provided on an outer side in a vehicle width direction of the seat cushion.

### SUMMARY

However, in the configuration as described in Literature 1, the floor anchor remains visible to passengers, and thus the design of the vehicle seat cannot be improved. In view of the above, the floor anchor may be disposed below the seat cushion in the vehicle width direction so that the floor anchor becomes invisible to passengers, and the webbing may be pulled upward from between the seat cushion and the seat back.

However, in such a configuration, the floor anchor is located in front of a rear end of the seat cushion when viewed in a longitudinal section that includes the floor anchor, the seat cushion, and the seat back and that is orthogonal to the vehicle width direction. The webbing thus extends obliquely rearward from the floor anchor and then is pulled out from between the seat cushion and the seat back. In this configuration, if the vehicle is involved in a collision and the seat shifts forward relative to the vehicle floor, the portion of the webbing that is sandwiched between the seat cushion and the seat back before the collision is pulled upward, which may reduce the restraint force of the webbing.

An object of the invention is to provide a vehicle seat that prevents a deterioration in the design of a vehicle and a reduction in the restraint force of a webbing.

A vehicle seat according to an aspect of the invention includes: a seat portion including a seat cushion and a seat back; and a seat belt mechanism, the seat belt mechanism including: a webbing; an anchor disposed to overlap with the seat portion when viewed from above, an end of the webbing being fixed to the anchor; a buckle provided in the seat cushion; and a tongue configured to be coupled to the buckle to cause a part of the webbing to function as a waist restraint section to restrain a waist portion of a passenger’s body, in which the anchor is disposed below the seat back and vertically below a rear end of the seat cushion or on a rear side of the rear end of the seat cushion, when viewed in a longitudinal section including the anchor and orthogonal to a vehicle width direction, and a portion of the webbing close to the anchor is pulled upward from between the seat cushion and the seat back.

### BRIEF DESCRIPTION OF DRAWINGS

Referring now to the attached drawings which form a part of this original disclosure, illustrative embodiments are shown.

FIG. 1 is a perspective view of a main part of a vehicle according to an exemplary embodiment. Referring now to the attached drawings which form a part of this original disclosure, illustrative embodiments are shown.

FIG. 2 is a longitudinal sectional view taken along line II–II of FIG. 1.

FIGS. 3A – 3C schematically illustrate operations of rear seats according to a comparative example (FIG. 3A), the exemplary embodiment (FIG. 3B), and a modified example (FIG. 3C).

### DETAILED DESCRIPTION OF EMBODIMENTS

### Exemplary Embodiment

### Vehicle Configuration

An exemplary embodiment of the invention will be described.

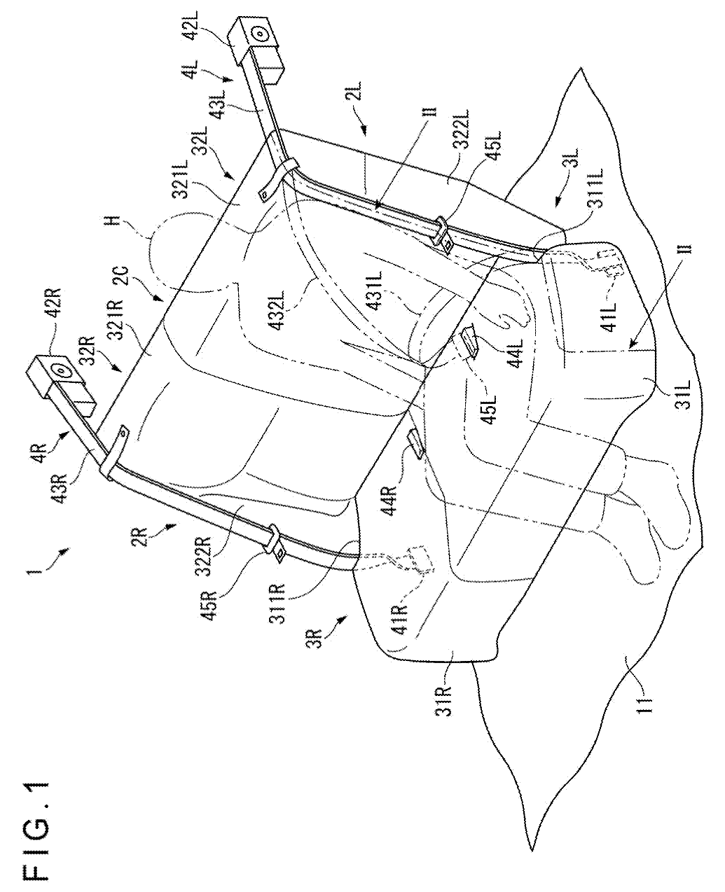

A vehicle 1 illustrated in FIG. 1 includes a left rear seat 2L, a right rear seat 2R, and a center rear seat 2C. The rear seats 2L, 2R, and 2C are located behind a driver’s seat or a front passenger seat (not illustrated).

The rear seats 2L, 2R respectively include rear seat portions 3L, 3R and rear seat belt mechanisms 4L, 4R. The rear seats 2L and 2R are each an exemplary vehicle seat. The rear seat portion 3L and 3R are each an exemplary seat portion.

The rear seat portions 3L, 3R respectively include seat cushions 31L, 31R and seat backs 32L, 32R.

The seat cushions 31L and 31R are located on a floor 11 of the vehicle 1. A notch 311L is provided at a left rear end of the seat cushion 31L. A notch 311R is provided at a right rear end of the seat cushion 31R. The notch 311L has a shape corresponding to a side bolster 322L described below of the seat back 32L so that the side bolster 322L fits into the notch 311L. The notch 311R has a shape corresponding to a side bolster 322R described below of the seat back 32R so that the side bolster 322R fits into the notch 311R.

The seat backs 32L, 32R respectively include backrests 321L, 321R that support a back portion of passenger H’s body and the side bolsters 322L, 322R that support a left upper portion of passenger H’s body. Lower ends of the side bolsters 322L, 322R are respectively positioned below upper ends of the seat cushions 31L, 32R so that lower portions of the side bolsters 322L, 322R are respectively brought into contact with inner surfaces of the notches 311L, 311R of the seat cushions 31L, 31R.

The rear seat belt mechanisms 4L, 4R respectively include anchors 41L, 41R, retractors 42L, 42R, webbings 43L, 43R, buckles 44L, 44R, and tongues 45L, 45R.

The anchors 41L, 41R are respectively arranged to overlap with the rear seat portions 3L, 3R when viewed from above. First ends of the webbings 43L, 43R are respectively fixed to the anchors 41L, 41R.

The retractor 42L is disposed behind a left end of the seat back 32L. The retractor 42R is disposed behind a right end of the seat back 32R. Second ends of the webbings 43L, 43R are respectively fixed to the retractors 42L, 42R. The retractors 42L, 42R respectively include retracting mechanisms (not illustrated) configured to retract the webbings 43L, 43R and locking mechanisms (not illustrated) configured to lock the webbings 43L, 43R when the vehicle 1 makes a sudden braking or a collision occurs.

The buckle 44L is fixed to a right rear end portion of the seat cushion 31L. The buckle 44R is fixed to a left rear end portion of the seat cushion 31R.

The webbings 43L, 43R respectively pass through the tongues 45L, 45R. Fastening the tongue 45L into the buckle 44L allows a portion of the webbing 43L pulled out from the retractor 42L that is on the anchor 41L side of the tongue 45L to function as a waist restraint section 431L that restrains a waist portion of passenger H’s body, and allows the rest of the webbing 43L to function as an upper body restraint section 432L that restrains an upper portion of passenger H’s body. Fastening the tongue 45R into the buckle 44R allows the webbing 43R, similarly to the webbing 43L, to function as a waist restraint section and an upper body restraint section.

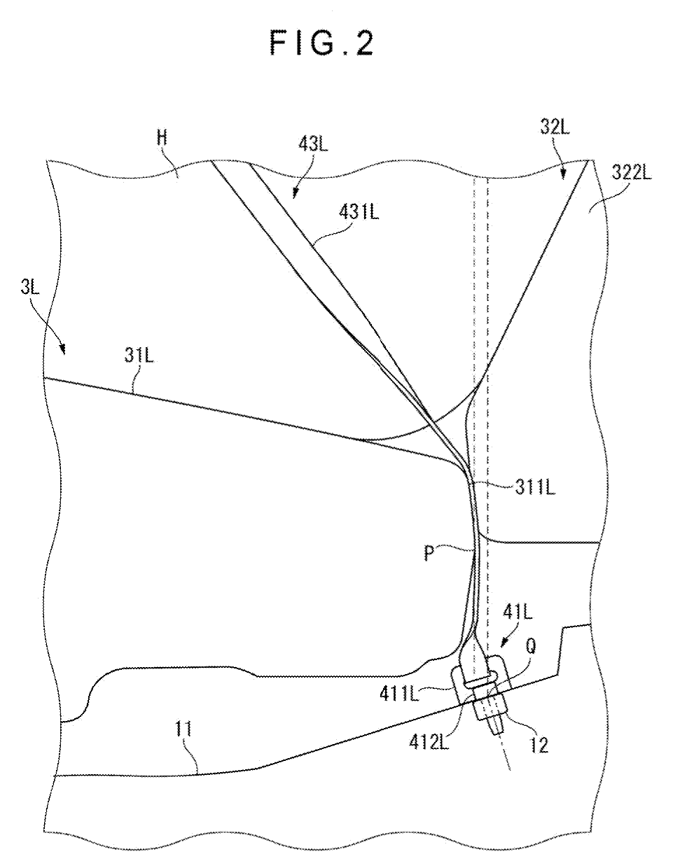

Referring to FIG. 2, a structural arrangement of the anchor 41L included in the rear seat belt mechanism 4L will be described in detail. FIG. 2 is a longitudinal sectional view taken along line II–II of FIG. 1. This longitudinal sectional view is a longitudinal sectional view that includes the anchor 41L, the seat cushion 31L, and the seat back 32L and that is taken along a plane orthogonal to a vehicle width direction.

As illustrated in FIG. 2, the anchor 41L includes a webbing fixing portion 411L to which the first end of the webbing 43L is fixed, and a bolt 412L extending from a center portion of the webbing fixing portion 411L to function as an attaching portion. The floor 11 is provided with a nut 12. Screwing the bolt 412L and the nut 12 together causes the anchor 41L to be positioned below the lower end of the side bolster 322L and vertically below a rear end P of the notch 311L of the seat cushion 31L, when viewed in the longitudinal section of FIG. 2. The anchor 41L located vertically below the rear end P means that a part of the anchor 41L is positioned vertically below the rear end P. In the exemplary embodiment, the anchor 41L is disposed so that an intersection point Q between a center axis of the bolt 412L and an upper surface of the floor 11 is positioned on a rear side of the vertical lower position of the rear end P. The anchor 41R has the same configuration as the anchor 41L. Screwing a bolt (not illustrated) of the anchor 41R and a nut (not illustrated) of the floor 11 together causes the anchor 41R to be positioned below the lower end of the seat back 32R and vertically below a rear end of the notch 311R of the seat cushion 31R, when viewed in a longitudinal section that includes the anchor 41R, the seat cushion 31R, and the seat back 32R and that is orthogonal to the vehicle width direction.

Arranging the anchors 41L, 41R as described above allows the webbings 43L, 43R to extend substantially vertically upward from the anchors 41L, 41R, pass between the notches 311L, 311R and the side bolsters 322L, 322R, and be pulled upward, as illustrated in FIG. 1.

### Operation of Rear Seat

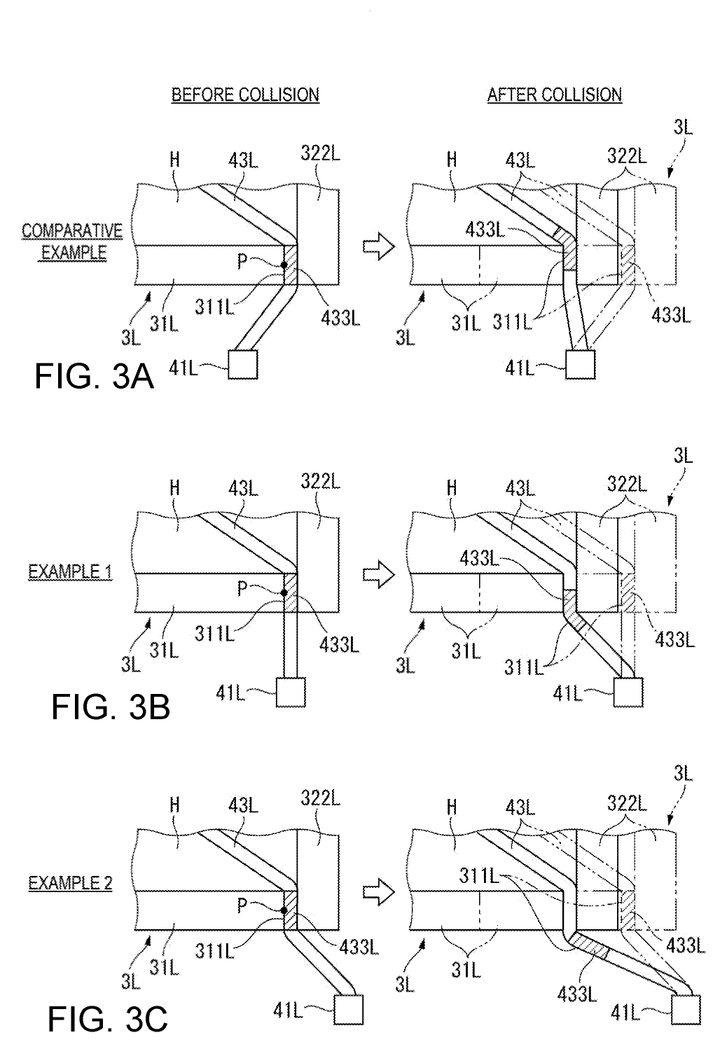

Subsequently, the operation of the rear seats 2L, 2R will be described with reference to schematic diagrams of their respective configurations. FIGS. 3A – 3C schematically illustrate the operations of the rear seats.

In Comparative Example illustrated in FIG. 3A, the anchor 41L is disposed below the lower end of the side bolster 322L and in front of the rear end P of the notch 311L, when viewed in a longitudinal section illustrating the same position as in FIG. 2. Example 1 illustrated in FIG. 3B corresponds to the left rear seat 2L illustrated in FIGS. 1 and 2. The anchor 41L is disposed below the lower end of the side bolster 322L and vertically below the rear end P of the notch 311L. The solid lines in the left-side diagrams and the two-dot chain lines in the right-side diagrams of Comparative Example and Example 1 indicate a state before the collision. The solid lines in the right-side diagrams of Comparative Example and Example 1 indicate a state after the collision.

In Comparative Example, when the vehicle 1 is involved in the collision and the rear seat portion 3L shifts forward relative to the floor 11, a portion 433L of the webbing 43L sandwiched between the notch 311L and the side bolster 322L before the collision (hereinafter may be referred to as “sandwiched portion 433L”) is pulled upward as indicated by the solid lines in the right-side diagram in FIG. 3A. The restraint force of the webbing 43L is thus reduced.

In contrast, when the rear seat portion 3L shifts frontward relative to the floor 11 in Example 1, the sandwiched portion 433L is pulled downward as indicated by the solid lines in the right-side diagram in FIG. 3B. The restraint force of the webbing 43L is thus prevented from being reduced.

### Effects of Exemplary Embodiment

According to the rear seats 2L, 2R described above, the anchors 41L, 41R are arranged to respectively overlap with the rear seat portions 3L, 3R when viewed from above. It is thus possible to prevent the anchors 41L, 41R from being visible to passenger H and prevents a reduction in the design appearance of the vehicle 1. Further, with the above arrangement of the anchors 41L, 41R relative to the seat cushions 31L, 31R and the seat backs 32L, 32R, a reduction in the restraint force of the webbings 43L, 43R can be prevented when the rear seat portions 3L, 3R shift frontward relative to the floor 11.

The portions of the seat backs 32L, 32R at which the webbings 43L, 43R are pulled out, that is, the lower ends of the side bolsters 322L, 322R, are respectively positioned below the upper ends of the seat cushions 31L, 31R. It is therefore possible to more effectively prevent the anchors 41L, 41R from being visible between the seat cushions 31L, 31R and the seat backs 32L, 32R.

The seat cushions 31L, 31R respectively include the notches 311L, 311R into which the side bolsters 322L, 322R fit. This allows the webbings 43L, 43R to be pulled out at a position that is further forward than a configuration in which the seat backs 32L, 32R only include the backrests 321L, 321R and the seat cushions 31L, 31R do not include the notches 311L, 311R.

The configuration of the vehicle seat of the invention is applied to the rear seats 2L, 2R that are likely to have a reduction in the restraint force of the webbings 43L, 43R due to the positional shift of the rear seat portions 3L, 3R rather than to the driver’s seat and the front passenger seat in each of which the buckle is movably arranged and the position of the webbing can be adjusted according to the physique of the passenger. Accordingly, it is possible to provide the rear seats 2L, 2R that prevent a reduction in the restraint force of the webbings 43L, 43R.

### Modified Examples

In the exemplary embodiment, the anchor 41L is disposed vertically below the rear end P of the notch 311L when viewed in the longitudinal section of FIG. 2. The anchor 41L, however, may be disposed on a rear side of the rear end P as in Example 2 illustrated in FIG. 3C. Also in such a configuration, when the rear seat portion 3L shifts frontward relative to the floor 11, the sandwiched portion 433L is pulled downward as indicated by the solid lines in the right-side diagram in FIG. 3C. The restraint force of the webbing 43L is thus prevented from being reduced.

The lower end portions of the seat backs 32L, 32R at which the webbings 43L, 43R are pulled out may be positioned at the same height as the upper ends of the seat cushions 31L, 31R or positioned above those upper ends.

In a configuration in which the seat backs 32L, 32R only include the backrests 321L, 321R and the seat cushions 31L, 31R do not include the notches 311L, 311R, the webbings 43L, 43R may be pulled out from between the backrests 321L, 321R and the seat cushions 31L, 31R.

The vehicle seat of the invention may be applied to a driver’s seat and a front passenger seat.

What is claimed is:

1. A vehicle seat, comprising:
a seat portion including a seat cushion and a seat back; and
a seat belt mechanism,
the seat belt mechanism comprising:
a webbing;
an anchor disposed to overlap with the seat portion when viewed from above, an end of the webbing being fixed to the anchor;
a buckle provided in the seat cushion; and
a tongue configured to be coupled to the buckle to cause a part of the webbing to function as a waist restraint section to restrain a waist portion of a passenger’s body, wherein
the anchor is disposed below the seat back and vertically below a rear end of the seat cushion or on a rear side of the rear end of the seat cushion, when viewed in a longitudinal section including the anchor and orthogonal to a vehicle width direction, and
a portion of the webbing close to the anchor is pulled upward from between the seat cushion and the seat back.

2. The vehicle seat according to claim 1, wherein
a lower end portion of the seat back at which the webbing is pulled out is positioned below an upper end of the seat cushion.

3. The vehicle seat according to claim 2, wherein
the seat back includes a backrest configured to support a back portion of the passenger’s body and a side bolster provided at an end of the backrest in the vehicle width direction and configured to support a side portion of the passenger’s body,
a notch is provided at a rear end portion of the seat cushion, the side bolster being fit into the notch, and
the anchor is disposed below a lower end of the side bolster and vertically below a rear end of the notch or on a rear side of the rear end of the notch.

4. The vehicle seat according to claim 1, wherein
the seat portion is a rear seat portion.
